(19) United States
(12) Patent Application Publication
(10) Pub. No.: US 2010/0305950 A1
(43) Pub. Date: Dec. 2, 2010

(54) AUDIO DEVICE FOR ADHERING TO FOLDABLE APPARATUS

(76) Inventor: Bart Vantieghem, Alpharetta, GA (US)

Correspondence Address: SEYFARTH SHAW LLP, 131 S. DEARBORN ST., SUITE 2400, CHICAGO, IL, 60603-5803, US

(21) Appl. No.: 12/841,808

(22) Filed: Jul. 22, 2010

Related U.S. Application Data
(63) Continuation-in-part of application No. 12/145,752, filed on Jun. 25, 2008.
(60) Provisional application No. 61/227,531, filed on Jul. 22, 2009.

(51) Int. Cl. G10L 21/00

(52) U.S. Cl. 704/272; 704/E21.001

(57) ABSTRACT

A first audio playback device securable with a second folding or foldable device that adapts the second device to carry and playback a recorded message, and a second audio play device that is adherable/securable with any item or device to allow audio record/playback via actuation of push buttons or the like. In certain forms, the item or device may be a picture frame or may be a photo print or the like that becomes part of the audio playback device assembly.

### CROSS-REFERENCE TO RELATED APPLICATION(S)

The present application is a continuation-in-part of U.S. Ser. No. 12/145,752, filed Jun. 25, 2008, and claims the benefit of U.S. Provisional Application No. 61,227,531, filed Jul. 22, 2010, the entirety of both of which is incorporated herein by reference.

### FIELD OF THE INVENTION

The invention relates to audio devices securable with another device so that movement of the other device activates the audio playback and, in particular, to audio devices that are recordable by a user or pre-recorded and that may be secured to a user-selected device and, more particularly, to such devices that may be secured with a user-selected device such as a folding apparatus which may be, as examples, an envelope or a greeting card, and relates to products to which an audio playback device may be secured such as a decorative ornament or picture frame, as mere examples.

### BACKGROUND

Currently, folding devices such as greeting cards and the like are known that include an electronic device having a pre-recorded audio track and/or a device that may record and re-record an audio track. The folding device includes a first portion permanently secured to one side of the greeting card, a second portion permanently secured to another side of the greeting card, and a portion that spans between the portions such that opening of the greeting card pulls the spanning portion relative one of the first and second portions, whichever includes the electronic device, to activate playback of the recorded audio. In other forms, a button may be depressed or actuated in order to activate playback and/or recording, if capable of such.

However, each of these greeting cards comes as a complete product for the user to purchase. That is, the decision to pair the electronic device and permanently secured portions with the greeting cards is outside of the control of the consumer. Either the card comes with an audio playback ability or it does not; either the audio playback ability is recordable or pre-recorded, with no choice to the consumer.

Accordingly, there has been a need for an improved apparatus for allowing customization of greeting cards and other folding or foldable devices.

### SUMMARY

In accordance with an aspect, an audio playback device is disclosed comprising an audio module including a circuit having a medium for storing audio, a speaker for playing audio stored on the medium, a power source for powering the audio, and a switch for activating playing of the audio stored on the medium, the audio playback device also comprising a substrate for carrying the audio module thereon, substrate adhesive disposed on at least a portion of the substrate for securing the module to a consumer item, and a module backing removable for exposing the substrate adhesive, whereby a consumer may remove the module backing and apply the substrate adhesive to the consumer item.

In some forms, the medium includes pre-recorded audio.

In some forms, the audio module circuit further includes a microphone for recording consumer-provided audio, and a recording actuator permitting the consumer to record audio to the medium. Actuation of the recording actuator may erase from the medium previously recorded consumer-provided audio. The audio module circuit may further include a frangible breakpoint connected to a removable tab, wherein removal of the removable tab prevents erasing of recorded audio.

In some forms, the switch is a button activated by a consumer applying pressure thereto to activate playback of the audio from the medium by the speaker.

In some forms, the audio playback device further including a slider, wherein the switch is activated by relative movement between the slider and the switch.

In another aspect, in combination with a consumer item having first and second item portions that are movable relative to each other, an audio playback device is disclosed comprising a tab securable with the first item portion, the tab including a tab portion having adhesive thereon and a removable tab backing for exposing the adhesive, whereby a consumer may remove the tab backing and apply the tab portion adhesive to the first item portion, comprising an audio module, the audio module including a circuit having a medium for storing audio, a speaker for playing audio stored on the medium, a power source for powering the audio, and a switch for activating playing of the audio stored on the medium, the switch being cooperatively connected to the tab, comprising a substrate for carrying the audio module thereon, comprising substrate adhesive disposed on at least a portion of the substrate for securing the module to the second item portion, and comprising a module backing removable for exposing the substrate adhesive, whereby a consumer may remove the module backing and apply the substrate adhesive to the second item portion such that relative movement of the first and second item portions causes relative movement between the tab and the switch, such tab movement in a first direction activating the switch for playing of the audio stored on the medium and such tab movement in a second direction de-activating the switch for turning of playing of the audio stored on the medium.

In some forms of the combination, the medium includes pre-recorded audio.

In some forms of the combination, the audio module circuit further includes a microphone for recording consumer-provided audio, and includes a recording actuator permitting the consumer to record audio to the medium. Actuation of the recording actuator may erase previously recorded consumer-provided audio. The audio module circuit may further include a frangible breakpoint connected to a removable tab, wherein removal of the removable tab prevents erasing of recorded audio.

### BRIEF DESCRIPTION OF THE DRAWINGS

In the Figures, FIGS. 1-4 are illustrations of steps for utilizing a user-installed audio playback device of the present invention in a folding device;

FIG. 5 is a further illustration of usage of the audio playback device;

FIGS. 6-8 are illustrations of a single form of the audio playback device;

FIG. 9 is an exploded illustration of a first embodiment of the present invention, the embodiment being a “slider”-type audio playback device, and packaging therefor; and

FIG. 10 is an exploded illustration of a second embodiment of the present invention, the embodiment being a “button”-type audio playback device, and packaging therefor.

### DETAILED DESCRIPTION

Referring to FIGS. 1-4, a user-selected folding apparatus in the form of a greeting card C is illustrated, and an audio playback device D of the present invention is illustrated. FIG. 1 shows a rear side of the audio playback device D and, specifically, illustrates a backing B that is removable to expose adhesive A on the audio playback device D. The adhesive may be pressure-sensitive adhesive, as a mere example.

Once the backing B has been removed, the adhesive A and the audio playback device D may be secured to the greeting card C. In greater detail, the audio playback device D is secured across the fold of the greeting card C (or, in other forms, a desired fold of another folding apparatus, not shown).

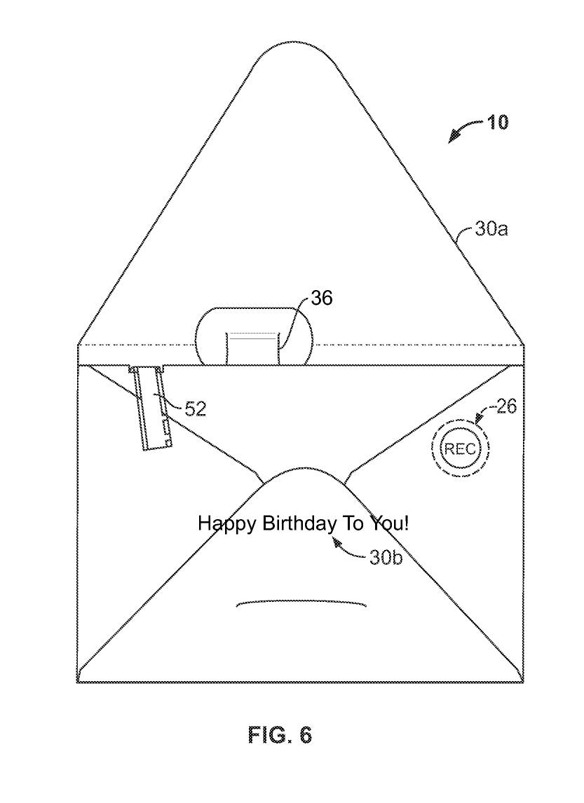

In the present form, the audio playback device D is recordable, as shown in FIG. 3. A REC label R on the audio playback device D is depressed or otherwise activated, at which time electrical components are activated for recording an audio message (see FIGS. 6-8, e.g., and accompanying description below). In other forms, the audio playback device D is pre-recorded. Generally, the audio playback device D is recordable and re-recordable. In the present form, as will be discussed in detail below, a “happy tab” (see tab 52 below and in FIGS. 6-8) may be removed to permanently fix the recording thereon, once the user is satisfied. The “happy tab” is referred to as such as it would, in the most preferred embodiment, have information to a consumer or user that states, for instance, “PLEASE REMOVE ONLY WHEN HAPPY WITH RECORDING.”

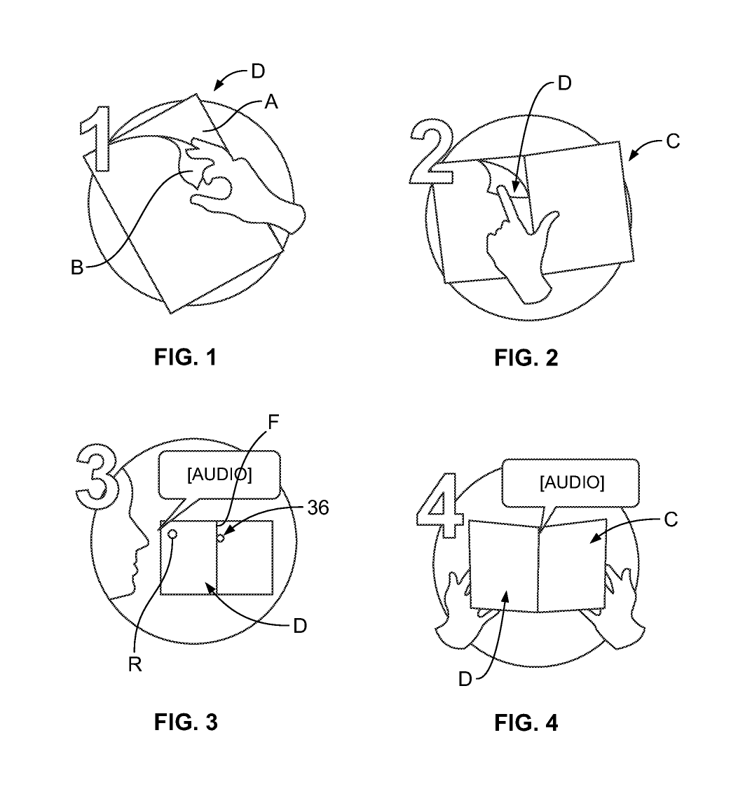

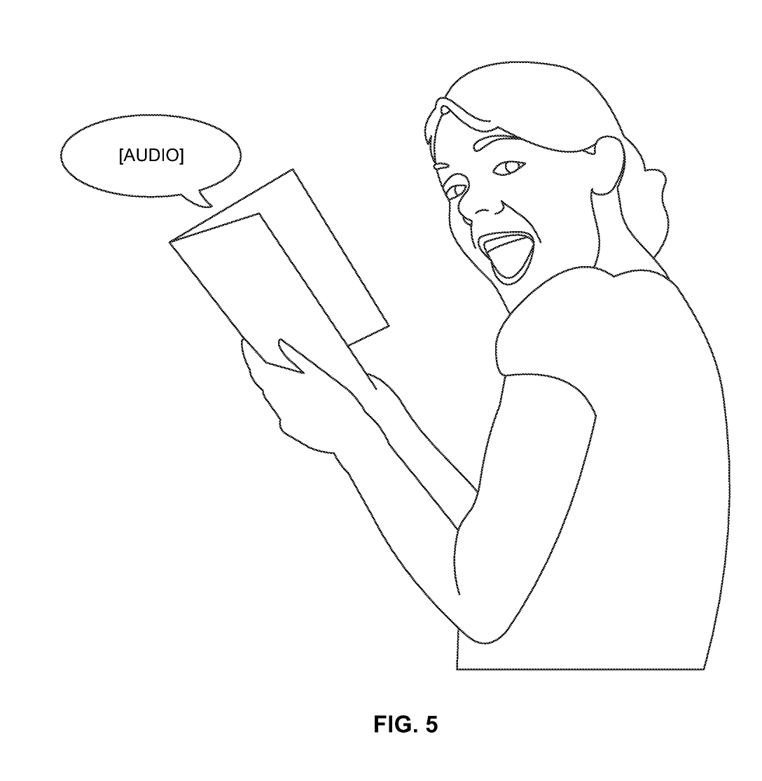

As can be seen in FIG. 5, the audio playback device D may be secured via the adhesive A to a greeting card C. As alternatives, the audio playback device D may be secured to any folding or foldable apparatus. This allows a user to turn many items into the equivalent of a personalized greeting card. As examples, a hotel could provide a guest with a bill and include an audio explanation of the charges, or could leave a message thanking the visitor for their stay. A person could secure the audio playback device D in a newspaper presented to someone with their breakfast in bed on their birthday or on mother's or father's day. A gift-giver could secure the audio playback device D in a book that marks a special event, such as a gift of a Bible or a gift of a survival guide for someone going to college. The age-old tradition of surreptitiously slipping notes into people's books or other belongings could be augmented by installing the audio playback device D in the same so that the person unexpectedly stumbles upon the message by hearing the recorded audio, such as by installing the audio playback device D in a suitcase.

Referring now to FIGS. 6-8, a folding or foldable apparatus is shown as an article carrier illustrated in the form of an envelope 10 having an audio playback device D capable of playing a user selected audio recording, accidental overwriting of the recording being protected and prevented. As used herein, the term prevented is used to mean stopped or the possibility being eliminated unless out-of-the ordinary steps are taken. The user would secure the audio playback device D in the envelope 10 or other apparatus, record an audio recording such as a spoken greeting or user selected music or any other audio recording or combination thereof, lock the recording, and then give the envelope 10 and audio playback device D either as a gift or as a companion to a gift or gift article such as a gift card or certificate, for instance. In this manner, the audio playback device D allows the user to personalize the giving of a gift card that is not typically considered personal.

As described herein, the present forms are often described in terms of a gift or a gift card, or often in terms of one person providing something to another person, and such is meant only in an exemplary manner. It should be noted that one may personalize, individualize, or simply tailor consumer and personal items or the like as one desires, regardless of whether a change of possession is ever intended.

Towards this end, the audio playback device D includes an electronic circuit device 12 including an output component in the form of a speaker 14, a power source in the form of a battery 16, an input component in the form of a microphone 18, and a storage medium in the form of an integrated circuit chip (IC) 20.

In a preferred form, the IC 20 is a re-writeable chip. A user uses the microphone 18 to input an audio stream that becomes the audio recording stored on the IC 20. As the user may, for any reason, be dissatisfied with a first recording, it is desirable to permit the user to change the recording. However, in some forms, it may be desirable to use a write-once integrated circuit.

Initially, the IC 20 is programmed to accept an audio recording. In some forms, the IC 20 may include audio instructions to a user on how to record an audio stream, and such instructions may be overwritten by the user recording their selected audio stream onto the IC 20.

To record a message, a record actuator 26 is provided by depressing the REC label R (FIG. 3). In a preferred form, the record actuator 26 is a switch that generally requires some intentional act to activate. For instance, a hole may be provided in a switch housing, and insertion of a pin into the hole depresses a plate to connect the switch and move the record actuator 26 to a closed circuit position that allows recording to the IC 20. However, it is also recognized that it is difficult for a user to manipulate a pin, for instance, and maintain the pin in the hole as is required while also recording a message. To be more specific and as an example, a user may choose to record an audio stream from an audio source such as a television or another speaker (i.e., a speaker other than the speaker 14 carried by the envelope 10), and such may require moving the envelope 10 and microphone 18 to a position proximate the audio source, and the actuator 26 must be held in the closed position during the recording. In order to minimize frustration and maximize ease of actuation for a user, the record actuator 26 is preferably simply in the form of a button 27. In one form, the record actuator 26 may be provided with a removable or frangible protector or cover so that, prior to a first use, the possibility of accidental actuation is minimized, such as from compression or jostling that may occur during shipping.

Once an audio stream has been recorded to the IC 20 via the microphone 18, the user may desire to review the recording. Generally, the microphone 18 is positioned at an interior portion of the envelope 10, and the envelope 10 includes a body generally formed of a folded paper blank 30. Therefore, the audio stream may be received by the microphone 18 through the paper 30. The record actuator 26 may be operated through the paper 30, which in some forms may have a small hole aligned with the above-described record actuator housing hole. As the recording may be made without opening the envelope 10, playback of the recording may be activated by opening an envelope flap 30a in a manner similar to that which is used in prior art audio-playing greeting cards, specifically, but pulling a play tab 36 to activate the IC 20 to provide the recorded audio to an amplifier 40 and the speaker 14. As can be seen in FIG. 3, the play tab 36 is secured on the other side of a fold F of the greeting card C so that opening of the greeting card C pulls the play tab 36 to activate the playing of the recording.

In other forms, it may be desirable to have the flap 30a opened to an intermediate position in order to record the audio stream, yet calibrate or coordinate the playback to occur when the flap 30a is in a fully-opened position. Advantageously, audio playback is desired when a recipient of the envelope 10 and its contents opens the envelope flap 30a to a position that permits withdrawal of the contents from the envelope 10, which generally requires the flap 30a to be fully-opened. As such, the envelope 10 may be partially opened during recording, with the flap 30a at a less-than-fully-opened position, to improve the clarity of the recording by not requiring the audio stream to pass through the paper 30.

It should be noted that the order of the steps of use may be changed. For instance, a user may record a message prior to removing the backing B and/or prior to securing the adhesive A with the foldable device, such as the envelope 10 or greeting card C.

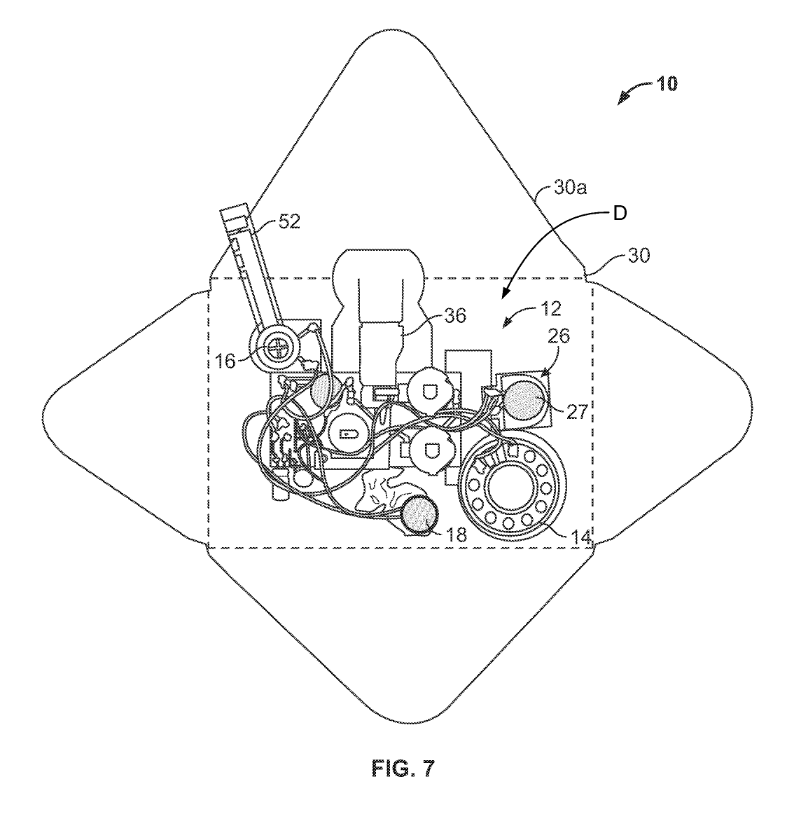

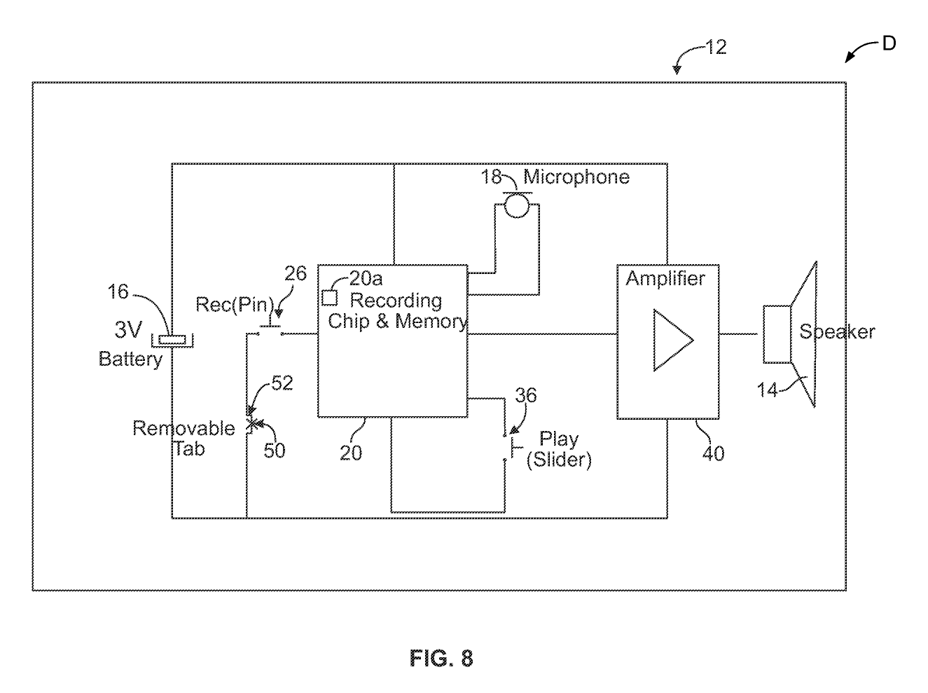

Once the user is satisfied with the recording, such as by reviewing the playback, the user can lock the recording to the IC 20. In the present and preferred form, the user locks the recording by literally breaking the circuit for the record actuator 26. Turning to FIG. 8, a block diagram of the presently described circuit is shown having the battery 16 connected across the IC 20 and across the amplifier 40 that powers the speaker 14. The battery 16 is also connected to one side of the record actuator 26, which is in turn connected on its other side to the IC 20. A breakpoint 50 is provided between the battery 16 and the record actuator 26. In the present form, the breakpoint 50 is connected to a thin strip of material referred to herein as tab 52 (see FIGS. 6 and 7). The tab 52 may be pulled away from the circuit components so that it breaks away from the circuit and is removed entirely from the audio playback device D. The record actuator 26 is connected to a pin 20a of the IC 20, as is readily understood, and the break at the breakpoint 50 due to removal of the tab 52 prevents power from reaching the record actuator pin 20a, and, thus, the IC 20 cannot be commanded to re-write over whatever audio stream recording is present on the IC 20.

As described then, a user is able to easily use the button 27 to record a message or audio stream to the IC 20, without difficulty that may be experienced with other types of record actuators. Yet, despite the ease of recording by pressing the button 27, the audio playback device D provides the ability to lock the recording on the IC 20, and prevents the accidental overwriting of the recording, by allowing the simple and elegant tab 52 solution for breaking the circuit and preventing power to reach the record actuator pin 20a on the IC 20.

The present invention in the form of the audio playback device D allows a user to provide a highly personalized gift presentation to a recipient. The user may select an envelope 10 or any other folding/foldable apparatus. The audio playback device D provides an easy-to-use button 27 to record a message or other audio stream to personalize the envelope 10. The breakpoint 50 allows the user to make sure that the ease of the button 27 does not result in accidental or inadvertent overwriting of the recorded audio stream, as well as prevents re-use or ‘re-gifting’ of the audio playback device D. The audio playback device D is thus able to be used with any folding/foldable article for presentation as a gift, particularly an article such as a gift card that is generally not considered personal to a recipient.

It should be noted that the electronic circuit device 12 may be in a variety of forms, including a simple electronic circuit device commonly employed in greeting cards with a permanent recording, more complex electronic circuit devices employed for user-recordable media, and the above-described recordable/re-recordable devices including a method or component for permanently/semi-permanently fixing the recording thereon, and combinations of both (for instance, a device which plays both a pre-recorded audio track and a user-recorded audio track).

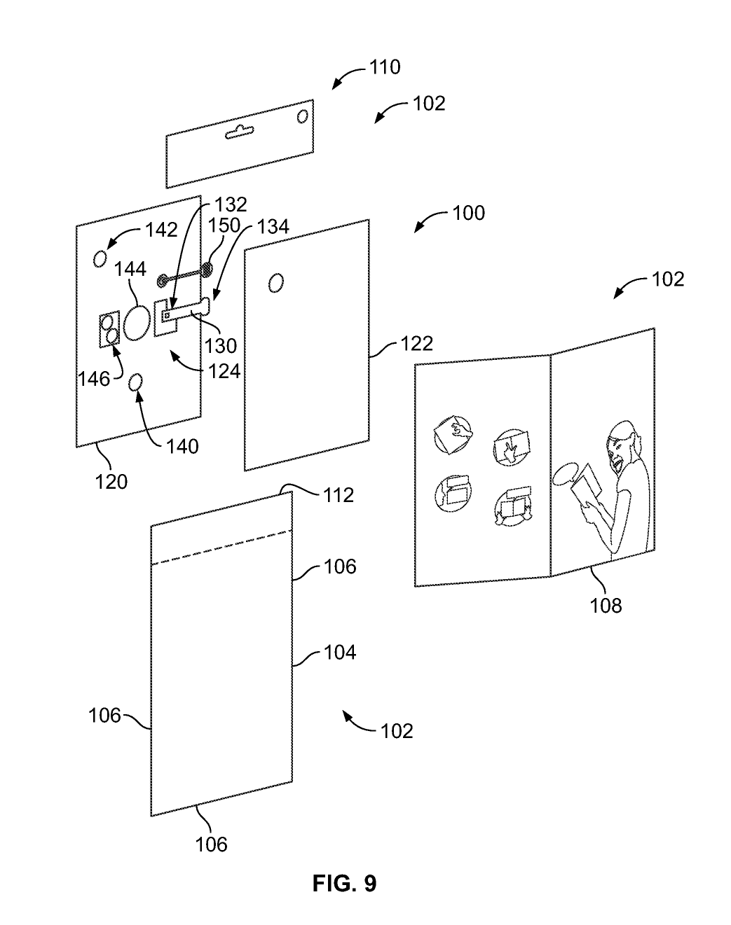

Turning now to FIG. 9, a form of the present invention is illustrated as audio playback assembly 100, shown in an exploded view with a form of packaging 102. The packaging includes a plastic or poly bag 104 of generally two sides, folded or heat sealed around three edges 106. The assembly 100 is received within a graphic or cover 108, and the assembly 100 and cover 108 are then placed inside the poly bag 104. It should be noted that, in a form, the assembly 100 and cover 108 may be placed between two sheets of poly material, and the bag 104 may then be formed (such as by cutting/heat sealing) therearound. Once the assembly 100 and cover 108 are disposed within the poly bag 104, a hanging tab 110 or other item may be secured to a top 112 of the poly bag 104 to provide for display, as an example. The assembly 100 includes a back or backing 120, a cover 122, and an audio module 124 between the backing 120 and cover 122.

The assembly 100 may be constructed in a number of manners. One or both of the backing 120 and cover 122 have a surface including adhesive facing the other, and the module 124 may be secured between the backing 120 and cover 122 by the adhesive or may be built into the backing 120, for instance. In one form, either the backing 120 or cover 122 is removable (i.e., may be peeled away from the assembly 100) in order to expose the adhesive, and the rest of the assembly 100 may then be adhered to another item (such as a book, greeting card, picture frame) via the adhesive (with the module 124 directly in contact with the item). In another form, either the backing 120 or the cover 122 has a second layer of adhesive and a removable adhesive backing (not shown) which is removed to allow the backing 120, module 124, and cover 122 to be secured to another time as a single unit.

The illustrated audio module 124 is a “slider”-type assembly, similar in operation to others of the devices discussed herein. That is, the module 124 includes a slider 130 having a first end 132 mechanically connected with the electronic circuitry of the module 124 so that movement of the slider 130 acts as an on/off mechanism. The assembly 100 is installable within an item (not shown), such as a folding item device, so that the assembly 100 is generally fixed relative to a first portion (not shown) of the item. Then, a second end 134 of the slider 130 is connectable with a second portion (not shown) of the item, the second portion being movable relative to the first portion. When the first and second portions are moved, relative to each other, the slider 130 is pulled or pushed relative to the rest of the module 124 and assembly 100 to turn on or off the playback feature of the module 124.

In greater detail, it can be seen that the module 124 includes a play button 140 and a record button 142. These, then, allow the present form of the assembly 100 to record an audio message, and to provide playback to a user in a manner other than by using the slider 130 (the play button 140 being useful, for instance, if the person recording the message has not secured the assembly 100 with an item, which may be the case if the assembly 100 is a gift). The module 124 further includes a speaker 144 and a battery (batteries) 146 and a variety of electronics for operating the device. Like other embodiments discussed herein, a frangible tab 150 is supplied that permanently fixes the recording and disables the record feature.

It should be emphasized that the cover 122 (or backing 120) may be removed for securing the assembly 100 with an item. In particular, a photo print may be secured over the module 124 and backing 120 after the cover 122 has been removed, converting the photo print into a part of the overall assembly 100.

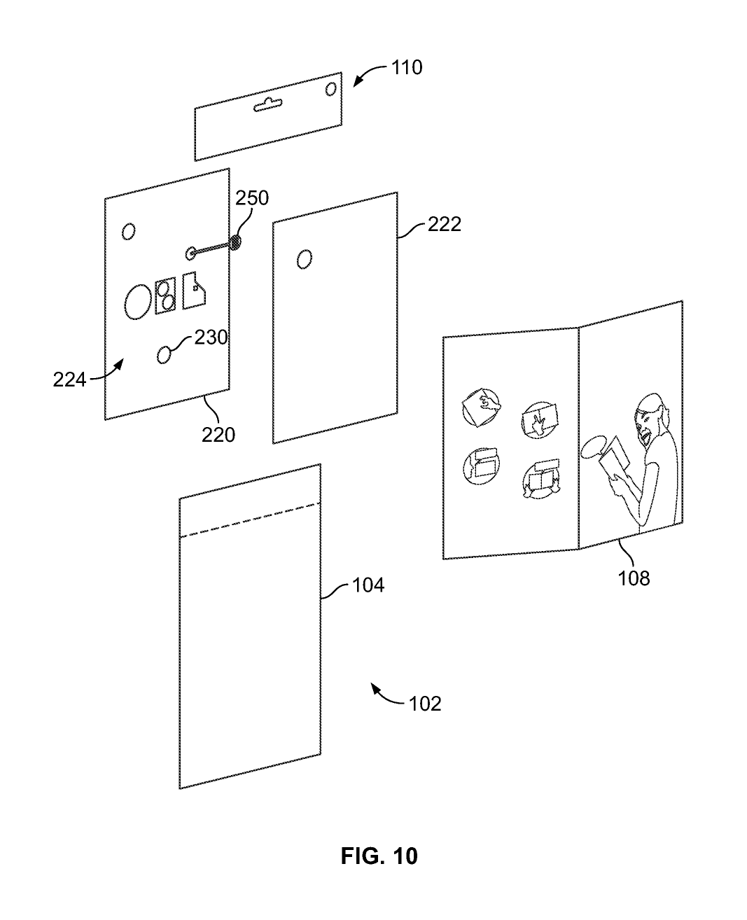

Turning now to FIG. 10, a second form of an assembly 200 is illustrated. The assembly 200 is depicted with packaging 102 as discussed above. The assembly 200 also has a backing 220 and cover 222, generally similar to those discussed for the assembly 100.

The assembly 200 also has a module 224 similar, but not identical, to the module 124, including a frangible tab 250. In particular, the module 224 is a “button”-type module, that is, having no slider 130. Instead, the module 224 is only activated by depressing the “play” button 230, as is illustrated.

As used herein, audio playback shall refer to any audio, whether it be pre-recorded or user-recorded, and whether it be talking, music, or any other audio track. For the forms of FIGS. 9 and 10, it should be noted that the record button would be omitted in a form that does not permit recording of audio tracks by a user, instead being pre-installed.

While the invention has been described with respect to specific examples including presently preferred modes of carrying out the invention, those skilled in the art will appreciate that there are numerous variations and permutations of the above described systems and techniques that fall within the spirit and scope of the invention.

What is claimed is:

1. An audio playback device comprising:
an audio module, the audio module including a circuit having:
a medium for storing audio,
a speaker for playing audio stored on the medium,
a power source for powering the audio, and
a switch for activating playing of the audio stored on the medium;
a substrate for carrying the audio module thereon;
substrate adhesive disposed on at least a portion of the substrate for securing the module to a consumer item;
a module backing removable for exposing the substrate adhesive, whereby a consumer may remove the module backing and apply the substrate adhesive to the consumer item.

2. The audio playback device of claim 1 wherein the medium includes pre-recorded audio.

3. The audio playback device of claim 1 wherein the audio module circuit further includes:
a microphone for recording consumer-provided audio, and
a recording actuator permitting the consumer to record audio to the medium.

4. The audio playback device of claim 3 wherein actuation of the recording actuator erases from the medium previously recorded consumer-provided audio.

5. The audio playback device of claim 4 wherein the audio module circuit further includes a frangible breakpoint connected to a removable tab, wherein removal of the removable tab prevents erasing of recorded audio.

6. The audio playback device of claim 1 wherein the switch is a button activated by a consumer applying pressure thereto to activate playback of the audio from the medium by the speaker.

7. The audio playback device of claim 1 further including a slider, wherein the switch is activated by relative movement between the slider and the switch.

8. In combination with a consumer item having first and second item portions that are movable relative to each other, an audio playback device comprising:
a tab securable with the first item portion, the tab including a tab portion having adhesive thereon and a removable tab backing for exposing the adhesive, whereby a consumer may remove the tab backing and apply the tab portion adhesive to the first item portion;
an audio module, the audio module including a circuit having:
a medium for storing audio,
a speaker for playing audio stored on the medium,
a power source for powering the audio, and
a switch for activating playing of the audio stored on the medium, the switch being cooperatively connected to the tab;
a substrate for carrying the audio module thereon;
substrate adhesive disposed on at least a portion of the substrate for securing the module to the second item portion; and
a module backing removable for exposing the substrate adhesive, whereby a consumer may remove the module backing and apply the substrate adhesive to the second item portion such that relative movement of the first and second item portions causes relative movement between the tab and the switch, such tab movement in a first direction activating the switch for playing of the audio stored on the medium and such tab movement in a second direction de-activating the switch for turning of playing of the audio stored on the medium.

9. The combination of claim 8 wherein the medium includes pre-recorded audio.

10. The combination of claim 8 wherein the audio module circuit further includes a microphone for recording consumer-provided audio, and a recording actuator permitting the a consumer to record audio to the medium.

11. The combination of claim 10 wherein actuation of the recording actuator erases previously recorded consumer-provided audio.

12. The combination of claim 11 wherein the audio module circuit further includes a frangible breakpoint connected to a removable tab, wherein removal of the removable tab prevents erasing of recorded audio.
